(19) United States
(12) Patent Application Publication
(10) Pub. No.: US 2024/0345597 A1
(43) Pub. Date: Oct. 17, 2024

(54) ROBOT, AND CONTROL METHOD AND CONTROL PROGRAM FOR THE SAME

(71) Applicant: Tokyo Robotics Inc., Tokyo (JP)

(72) Inventors: Kenta KATO, Tokyo (JP); Akari OSHIMA, Tokyo (JP); Yuki MATSUO, Tokyo (JP)

(21) Appl. No.: 18/749,699

(22) Filed: Jun. 21, 2024

Related U.S. Application Data
(63) Continuation of application No. PCT/JP2022/034538, filed on Sep. 15, 2022.

(30) Foreign Application Priority Data
Dec. 22, 2021 (JP) 2021-207859

(51) Int. Cl. G05D 1/639; B25J 5/00; B25J 9/00; B25J 9/16; G05D 107/40

(52) U.S. Cl. CPC G05D 1/642; B25J 5/00; B25J 9/0003; B25J 9/1664; G05D 2107/40

(57) ABSTRACT

A robot is able to close a door when a mobile base of the robot cannot move to a front face side of the door. A tool is provided on an arm part of the robot and the tool is hooked on or holds door. A drives the mobile base and/or the arm part in a situation where the mobile base is on a back face side of the opened door, to hook the tool on the door or to make the tool hold the door, drives the mobile base and/or the arm part to move the tool hooked on or holding the door in a direction in which the door is closed and thus to decrease an opening angle of the door, and drives the mobile base and/or the arm part to push the front face of the door with the decreased opening angle.

### CROSS-REFERENCE TO RELATED APPLICATION

This application is a continuation application of PCT/JP2022/034538, filed on Sep. 15, 2022, which claims the benefit of priority of Japanese Patent Application No. 2021-207859, filed on Dec. 22, 2021, the entire contents of which are incorporated herein by reference.

### TECHNICAL FIELD

The invention relates to a robot, and a control method and a control program for the robot.

### BACKGROUND ART

With advances in robot technology, the utilization of mobile robots in various environments has been considered. A robot needs to open and close a door depending on an environment, and there has been proposed a robot that is capable of opening and closing a door (Non Patent Literature 1).

The robot (mobile manipulator) disclosed in Non Patent Literature 1 is configured to be able to execute a door opening phase and a door closing phase. In the door closing phase, the robot closes a door by coming around to a front face side of the door and pushing the door from the front face side. Here, a front face of the door refers to, of two faces of the door, a face facing the robot when the door is in a closed state, and a back face refers to a rear face opposite to the front face.

### CITATION LIST

### Non-Patent Literature

Non-Patent Literature 1: Nagatani, K. and Yuta, S., “Designing strategy and implementation of mobile manipulator control system for opening door,” Proceedings of IEEE International Conference on Robotics and Automation, Vol. 3, IEEE, 1996.

### SUMMARY OF INVENTION

### Technical Problem

However, in an environment with a limited passable area for a robot, such as a narrow passageway, when there exists a door that is opened in such a manner as to block a passage, it is impossible to make a mobile base of the robot come around to the front face side of the door, in some cases. In such a case, the robot disclosed in Non-Patent Literature 1 cannot push the door from the front face and therefore cannot close the door.

The present invention has been made to solve the above-described technical problem, and an object thereof is to close a door in a situation where it is impossible to make a mobile base move to the front face side of the door.

### Solution to Problem

The above-described technical problem can be solved by a robot with configurations as described below, or the like.

Specifically, a robot according to the present invention includes: a mobile base; an arm part that extends from the mobile base and is driven in such a manner as to be able to change its posture; a tool that is provided at a distal end of the arm part and is configured to be hooked on or to hold a door; and a controller that controls driving of the mobile base and of the arm part, and wherein the door has a front face that is a face facing the mobile base in a closed state, and a back face that is a rear face opposite to the front face, and wherein the controller drives the mobile base and/or the arm part in a situation where the mobile base is on a back face side of the opened door, to hook the tool on the door or to make the tool hold the door, drives the mobile base and/or the arm part to move the tool hooked on or holding the door in a direction in which the door is closed and thus to decrease an opening angle of the door, and drives the mobile base and/or the arm part to push the front face of the door with the decreased opening angle.

According to such a configuration, the door is pushed after the opening angle thereof is decreased, and turns until reaching a door frame. In other words, the door is closed through a two-step motion. Accordingly, the door can be closed efficiently in a situation where the mobile base cannot move to the front face side of the door.

When the tool hooked on or holding the door comes off the door, the controller may stop moving the tool in the direction in which the door is closed, and may initiate a motion of pushing the front face of the door.

According to such a configuration, a time period of transition to the motion of pushing the front face of the door after the tool comes off the door during the motion of decreasing the opening angle is shortened. Accordingly, the door can be closed efficiently.

After moving the tool hooked on or holding the door in the direction in which the door is closed, the controller may set a target position of the arm part to push the front face of the door, make an attempt to see whether it is possible to plan a trajectory of the arm part along which the arm part is moved to the target position, and when the trajectory is successfully planned, initiate a motion of pushing the front face of the door, and when the trajectory fails to be planned, perform a motion of decreasing the opening angle of the door again by moving the tool hooked on or holding the door in the direction in which the door is closed.

According to such a configuration, the opening angle of the door is decreased to such an extent that the arm part can be moved to the target position of the arm part to push the front face of the door. Accordingly, the door can be more reliably closed.

After moving the tool hooked on or holding the door in the direction in which the door is closed, the controller may set a target position of the arm part to push the front face of the door, set a target position of the mobile base based on the target position of the arm part, attempt to plan a path along which the mobile base is moved to the target position of the mobile base, and when the path is successfully planned, initiate a motion of pushing the front face of the door, and when the path fails to be planned, perform a motion of decreasing the opening angle of the door again by moving the tool hooked on or holding the door in the direction in which the door is closed.

According to such a configuration, the opening angle of the door is decreased to such an extent that the mobile base can be moved to the target position of the mobile base to push the front face of the door. Accordingly, the door can be more reliably closed.

Another aspect of the present invention is a method of controlling a robot, the robot including a mobile base, an arm part that extends from the mobile base and is driven in such a manner as to be able to change its posture, and a tool that is provided at a distal end of the arm part and is configured to be hooked on or to hold a door, the door having a front face that is a face facing the mobile base in a closed state, and a back face that is a rear face opposite to the front face, the control method including the steps of: driving the mobile base and/or the arm part in a situation where the mobile base is on a back face side of the opened door, to hook the tool on the door or to make the tool hold the door; driving the mobile base and/or the arm part to move the tool hooked on or holding the door in a direction in which the door is closed and thus to decrease an opening angle of the door; and driving the mobile base and/or the arm part to push the front face of the door with the decreased opening angle.

Another aspect of the present invention is a program of controlling a robot, the robot including a mobile base, an arm part that extends from the mobile base and is driven in such a manner as to be able to change its posture, and a tool that is provided at a distal end of the arm part and is configured to be hooked on or to hold a door, the door having a front face that is a face facing the mobile base in a closed state, and a back face that is a rear face opposite to the front face, the control program including the steps of: driving the mobile base and/or the arm part in a situation where the mobile base is on a back face side of the opened door, to hook the tool on the door or to make the tool hold the door; driving the mobile base and/or the arm part to move the tool hooked on or holding the door in a direction in which the door is closed and thus to decrease an opening angle of the door; and driving the mobile base and/or the arm part to push the front face of the door with the decreased opening angle.

According to such a configuration, the door is pushed after the opening angle thereof is decreased, and turns until reaching a door frame. In other words, the door is closed through a two-step motion. Accordingly, the door can be closed efficiently in a situation where the mobile base cannot be moved to the front face side of the door.

### Advantageous Effect of Invention

According to the present invention, the door is pushed after the opening angle thereof is decreased, and turns until reaching a door frame. Accordingly, the door can be closed in a situation where a mobile base cannot be moved to the front face side of the door.

### BRIEF DESCRIPTION OF DRAWINGS

FIG. 1A is a side view of a robot according to an embodiment of the present invention, and

FIG. 1B is a top view of the robot.

FIG. 2 is a plane view showing an example of an environment in which the robot shown in FIG. 1 is utilized.

FIG. 3 is a block diagram of the robot shown in FIGS. 1A and 1B.

FIGS. 4A and 4B are diagrams for describing the recognition of a pose (position and orientation) of a door, wherein FIG. 4A is a plane view showing the surroundings of the door, and FIG. 4B is a diagram of the door viewed from a back face side.

FIG. 5 is a flowchart of a door closing motion process according to a first embodiment of the present invention.

FIG. 6 is a detailed flowchart of a door pulling motion process.

FIGS. 7A and 7B are diagrams for describing a door pulling motion of the robot, shown correspondingly to FIG. 2.

FIG. 8A is a diagram for describing a trajectory of an edge of the door, and FIG. 8B is a diagram for describing a trajectory of a tool in the first embodiment of the present invention.

FIG. 9 is a diagram in which the trajectory of the edge of the door is depicted on the plane view shown in FIG. 7A.

FIG. 10 is a detailed flowchart of a door pushing motion process.

FIGS. 11A and 11B are diagrams for describing a door pushing motion of the robot, shown correspondingly to FIG. 2.

FIG. 12 is a diagram for describing a trajectory of the tool in a second embodiment of the present invention, shown correspondingly to FIGS. 8A and 8B.

FIGS. 13A and 13B are diagrams for describing the trajectory of the tool in a modification of the second embodiment of the present invention, shown correspondingly to FIGS. 8A and 8B.

FIG. 14 is a diagram for describing a trajectory of the tool in a third embodiment of the present invention, shown correspondingly to FIGS. 8A and 8B.

FIG. 15 is a diagram for describing a trajectory of the tool in a fourth embodiment of the present invention, shown correspondingly to FIGS. 8A and 8B.

FIG. 16 is a detailed flowchart of a door pulling motion process in a fifth embodiment of the present invention.

FIGS. 17A and 17B are diagrams for describing a motion of hooking the tool on the edge of the door in the fifth embodiment of the present invention, shown correspondingly to FIGS. 4A and 4B.

FIG. 18 is a detailed flowchart of a door pulling motion process in a sixth embodiment of the present invention.

FIGS. 19A and 19B are diagrams for describing a motion of hooking the tool on the edge of the door in the sixth embodiment of the present invention, shown correspondingly to FIGS. 4A and 4B.

FIG. 20 is a flowchart of a door closing motion process according to an eighth embodiment of the present invention.

FIG. 21 shows a modification of a place where a tool is hooked, shown correspondingly to FIGS. 4A and 4B.

### DESCRIPTION OF EMBODIMENTS

Hereinafter, preferred embodiments of the present invention are described in detail with reference to the accompanying drawings.

### 1. First Embodiment

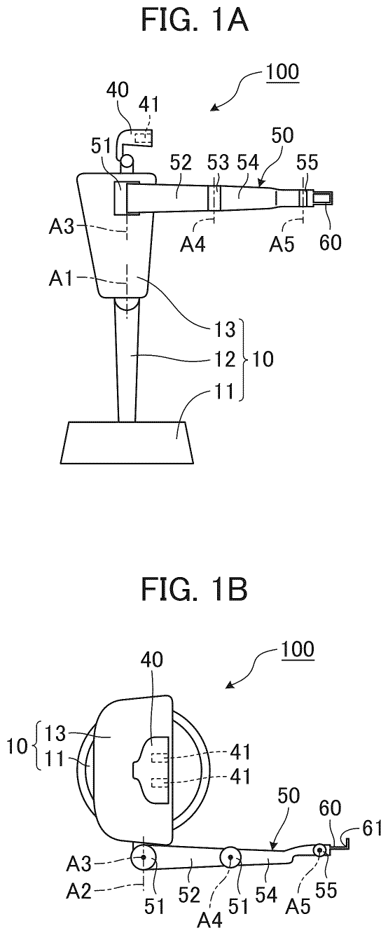

First, an example in which the present invention is applied to a robot is described as a first embodiment. FIGS. 1 to 3 are diagrams for describing an example configuration of a robot 100 according to the first embodiment. The robot 100 is supposed to be utilized in an environment with a door.

FIGS. 1A to 1B are diagrams for describing the configuration of the robot 100, wherein FIG. 1A is a side view mainly showing an example of an outer appearance of the robot 100, and FIG. 1B is a plane view mainly showing an example of the outer appearance of the robot 100. As shown in the drawings, the robot 100 has a generally human-like shape and includes a mobile wheeled platform 11, a leg part 12 supported by the mobile wheeled platform 11, a torso part 13 supported by the leg part 12, and a head part 40 and an arm part 50 supported by the torso part 13.

The mobile wheeled platform 11 is formed in such a manner as to be able to move on a surface (floor surface) where the robot 100 is placed. Specifically, the mobile wheeled platform 11 includes a plurality of drive wheels (not shown). When the plurality of drive wheels rotates, the mobile wheeled platform 11 moves. The mobile wheeled platform is, for example, an omnidirectional mobile wheeled platform configured to be able to move in all directions, and the drive wheels are, for example, omni-wheels.

In the following, “above/upward” and “below/downward” refer to an upper side and a lower side in a vertical direction, respectively, on the basis of a state where the mobile wheeled platform 11 is placed on a horizontal surface.

The leg part 12 extends upward from the mobile wheeled platform 11, as a component corresponding to a human leg in the generally human-like robot 100. The torso part 13 is arranged above the leg part 12, as a component corresponding to a human torso in the generally human-like robot 100, and is provided on the leg part 12 rotatably around an axis A1 extending substantially vertically.

Hereinafter, the mobile wheeled platform 11, the leg part 12, and the torso part 13 are also collectively referred to as “mobile base 10”.

The head part 40 is arranged above the torso part 13, as a component corresponding to a human head in the generally human-like robot 100, and is provided on the torso part 13 in such a manner as to be able to swing and rotate. The head part 40 has a front face that is recognizable as a face when seen by humans.

The head part 40 includes image generation means 41 for capturing an image of the surroundings of the robot 100 and generating a captured image. For the image generation means 41, for example, a black and white camera, a color camera, an IR camera, a 3D camera, or an RGBD camera can be used.

The arm part 50 extends from the torso part 13, as a component corresponding to a human arm in the generally human-like robot 100, and can change the posture thereof. Specifically, the arm part 50 includes a first joint part 51 provided on the torso part 13, a first link part 52 extending from the first joint part 51, a second joint part 53 provided on a distal end of the first link part 52, a second link part 54 extending from the second joint part 53, and a third joint part 55 provided on a distal end of the second link part 54. The third joint part 55 is also referred to as “distal end of the arm part 50”.

The first joint part 51 is rotatable around a substantially horizontal axis A2, with respect to the torso part 13. When the first joint part 51 rotates, the first link part 52, the second joint part 53, the second link part 54, and the third joint part 55 rotate around the axis A2. FIG. 1 (a) and 1 (b) show a state in which the first link part 52 is kept substantially horizontal.

The first link part 52, in the state of being kept substantially horizontal (the state shown in FIGS. 1A and 1B), can swing with respect to the torso part 13, around an substantially vertical axis A3 passing through the first joint part 51. The second link part 54, in the state where the first link part 52 is kept substantially horizontal (the state shown in FIGS. 1A and 1B), can swing with respect to the first link part 52, around a substantially vertical axis A4 passing through the second joint part 53. In other words, the arm part 50 can change the posture thereof.

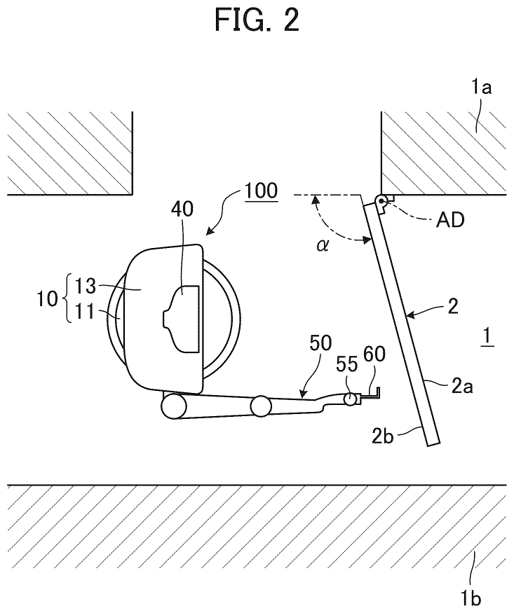

When the robot 100 as described above is utilized in an environment with a door, a passage of the robot 100 may be blocked by the opened door. FIG. 2 is a plane view showing an example of an environment with a door.

In the environment shown in FIG. 2, a pair of walls 1a, 1b are installed with a space in between, and a passageway 1 is formed between the wall 1a and the wall 1b. In the one wall 1a, a door 2 is provided rotatably around a rotation axis AD extending substantially vertically. In a state where the door 2 is opened, a space between the door 2 and the other wall 1b is narrower than the mobile wheeled platform 11 of the robot 100, and a passage of the robot 100 is blocked by the door 2.

In the state shown in FIG. 2, it is impossible to make the robot 100 move to a front face 2a side of the door 2. Accordingly, the robot 100 is configured to be able to decrease an opening angle α of the door 2 from a back face 2b side of the door 2. Here, the front face 2a of the door 2 refers to, of two large-area faces (2a, 2b) of the door 2, a face facing the robot 100 when the door is in a closed state, and the back face 2b refers to a rear face opposite to the front face 2a.

As shown in FIGS. 1A, 1B and 2, the robot 100 further includes a tool 60 provided on the third joint part 55 of the arm part 50. The tool 60, in the state where the first link part 52 is kept substantially horizontal (the state shown in FIGS. 1A and 1B), can swing with respect to the second link part 54, around a substantially vertical axis A5 passing through the third joint part 55.

The tool 60 is formed in a generally L shape and can be hooked on an edge of the door 2. The tool 60 is moved in such a manner that a corner portion 61 comes closer to the edge of the door 2, whereby the tool 60 is hooked on the edge of the door 2.

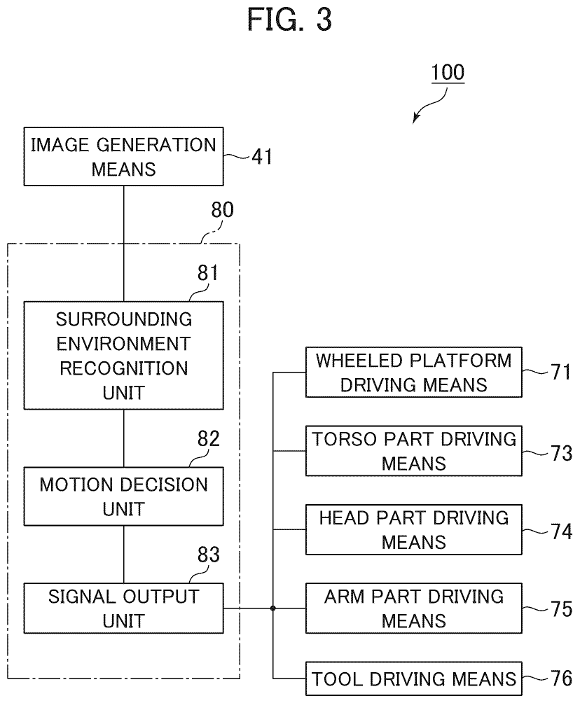

FIG. 3 is a block diagram of the robot 100. As shown in FIG. 3, the robot 100 includes wheeled platform driving means 71, torso part driving means 73, head part driving means 74, arm part driving means 75, tool driving means 76, and a controller 80.

The wheeled platform driving means 71 causes the drive wheels (not shown) on the mobile wheeled platform 11 to rotate. The wheeled platform driving means 71 is, for example, one or more motors mounted on the mobile wheeled platform 11. The torso part driving means 73 causes the torso part 13 to rotate with respect to the leg part 12. The torso part driving means 73 is, for example, one or more motors mounted on the leg part 12. The head part driving means 74 causes the head part 40 to swing and also rotate with respect to the torso part 13. The head part driving means 74 is, for example, one or more motors mounted on the torso part 13.

The arm part driving means 75 changes the posture of the arm part 50. The arm part driving means 75 includes, for example, one or more motors that are mounted on the torso part 13 and cause the first joint part 51 to rotate with respect to the torso part 13, one or more motors that are mounted on the first joint part 51 and cause the first link part 52 to swing with respect to the torso part 13, and one or more motors that are mounted on the second joint part 53 and cause the second link part 54 to swing with respect to the first link part 52.

The tool driving means 76 causes the tool 60 to swing with respect to the second link part 54 of the arm part 50. The tool driving means 76 is, for example, one or more motors mounted on the third joint part 55 of the arm part 50.

The controller 80 controls driving of the wheeled platform driving means 71, the torso part driving means 73, the head part driving means 74, the arm part driving means 75, and the tool driving means 76. The controller 80 includes functional units, such as a surrounding environment recognition unit 81, a motion decision unit 82, and a signal output unit 83.

The controller 80 is, for example, an information processing device that is configured with a central processing unit (CPU) as a processor, a read only memory (ROM) and a random access memory (RAM) as storage media, an input/output interface (I/O interface), and the like being connected through a bus. The ROM stores a program (control program) for implementing the functions of the surrounding environment recognition unit 81, the motion decision unit 82, and the signal output unit 83. In other words, the controller 80 is configured to implement the functions of the each functional unit, such as the surrounding environment recognition unit 81, the motion decision unit 82, and the signal output unit 83, by executing the program stored in the ROM.

Note that the components described above as a processor and storage media used to configure the controller 80 are illustrative purposes only, and in addition thereto or in place thereof, a GPU, a flash memory, a hard disk, a storage, or the like may be included. Moreover, the functions of the above-described each functional unit do not necessarily need to be implemented only by the controller 80, and may be configured to be implemented by a plurality of controllers selected as appropriate for each functional unit, individually or in cooperation with each other.

The functions of each functional unit of the controller 80 are described below.

The surrounding environment recognition unit 81 recognizes an environment around the robot 100. Specifically, the surrounding environment recognition unit 81 obtains information on a captured image generated by the image generation means 41, as information on an environment around the robot 100, and recognizes the environment around the robot 100 based on the obtained information. Examples of the information on the captured image include brightness information, RGB values, and a 3-D point cloud. When the door 2 (see FIG. 2) appears in the captured image generated by the image generation means 41, the surrounding environment recognition unit 81 recognizes that the door 2 exists around the robot 100, and also recognizes a pose (position and orientation) of the door 2.

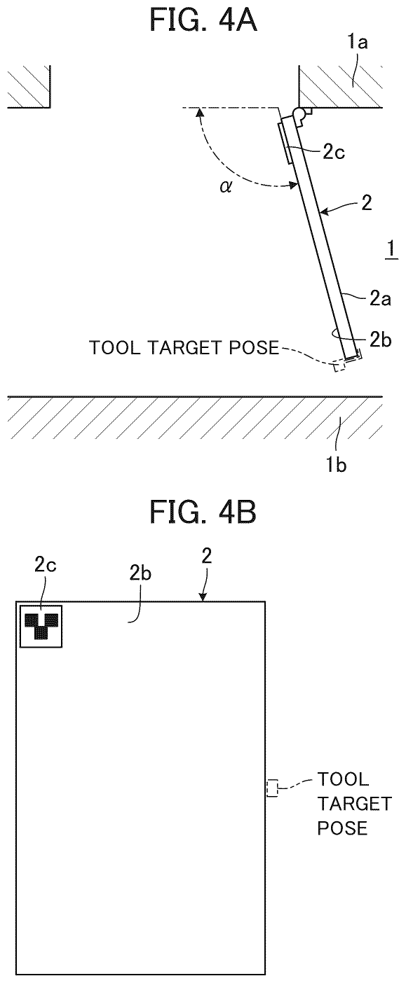

FIGS. 4A and 4B are diagrams for describing the recognition of the pose of the door 2, wherein FIG. 4A is a plane view showing surroundings of the door 2, and FIG. 4B is a diagram of the door 2 viewed from the back face 2b side. As obvious from FIGS. 4A and 4B, a marker 2c is used to recognize the pose of the door 2 in the present embodiment. Examples of the marker 2c include an ArUco marker, a Pitag marker, and the like. The marker 2c is placed on the back face 2b of the door 2. The surrounding environment recognition unit 81 recognizes the pose of the door 2, based on the marker 2c appearing in the captured image generated by the image generation means 41.

Note that the pose of the door 2 may be recognized by calculating poses of representative points of the door 2 from the information on the captured image of the door 2 and features of the representative points. For the calculation of the poses of the representative points, template matching, point set registration, or the like can be used.

Moreover, since the door 2 has a flat-plate shape in many cases, plane detection may be performed by using 3-D point cloud information, the center of the plane portion may be calculated as the position of the door 2, and the orientation of the door 2 may be calculated from the direction of a normal to the plane. Since the back face 2b of the door 2 has a rectangular shape in many cases, the pose of the door 2 may be calculated by performing rectangle recognition or the like. After various door images are learned by using deep learning such as Single Shot Multibox Detector (SSD) or You Only Look Once (YOLO), the pose of the door 2 may be detected.

Referring back to FIG. 3, the motion decision unit 82 decides the motions of the mobile wheeled platform 11, the torso part 13, the head part 40, the arm part 50, and the tool 60, based on the environment around the robot 100 recognized by the surrounding environment recognition unit 81. Specifically, when the surrounding environment recognition unit 81 recognizes that the door 2 exists around the robot 100, the motion decision unit 82 determines, based on the recognized pose of the door 2, whether the mobile base 10 sits on the back face 2b side of the opened door 2. When it is determined that the mobile base 10 sits on the back face 2b side of the opened door 2, the motion decision unit 82 decides to cause the mobile wheeled platform 11, the torso part 13, the head part 40, the arm part 50, and the tool 60 to make motions in such a manner as to decrease the opening angle α of the door 2 by pulling the door 2 and then to close the door 2 by pushing the door 2.

The signal output unit 83 outputs control signals for driving the wheeled platform driving means 71, the torso part driving means 73, the head part driving means 74, the arm part driving means 75, and the tool driving means 76, based on the motions decided by the motion decision unit 82. When the wheeled platform driving means 71, the torso part driving means 73, the head part driving means 74, the arm part driving means 75, and the tool driving means 76 are driven according to the control signals, the mobile wheeled platform 11, the torso part 13, the head part 40, the arm part 50, and the tool 60 make the motions decided by the motion decision unit 82.

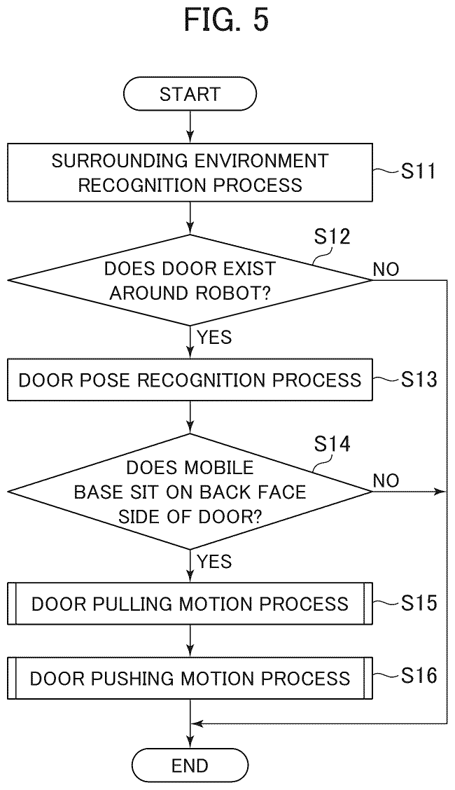

FIG. 5 is a flowchart of a process for a motion of closing the door 2 (hereinafter, also referred to as “door closing motion process”). As obvious from FIG. 5, when the door closing motion process starts, the controller 80 performs a surrounding environment recognition process of recognizing an environment around the robot 100 (S11). After the surrounding environment recognition process (S11), the controller 80 determines whether the door 2 exists around the robot 100 (S12). When the door 2 exists around the robot 100 (YES at S12), the controller 80 performs a door pose recognition process for recognizing the pose of the door 2 (S13). When the door 2 does not exist around the robot 100 (NO at S12), the door closing motion process is terminated.

In the door pose recognition process (S13), the controller 80 recognizes the pose of the door 2, based on the marker 2c appearing in a captured image generated by the image generation means 41.

After the door pose recognition process (S13), the controller 80 performs a process of determining, based on the recognized pose of the door 2, whether the mobile base 10 sits on the back face 2b side of the opened door 2 (S14). When the mobile base 10 sits on the back face 2b side of the opened door 2 (YES at S14), a door pulling motion process of pulling the door 2 to decrease the opening angle α of the door 2 is performed (S15). When the mobile base 10 does not sit on the back face 2b side of the opened door 2 (NO at S14), the door closing motion process is terminated.

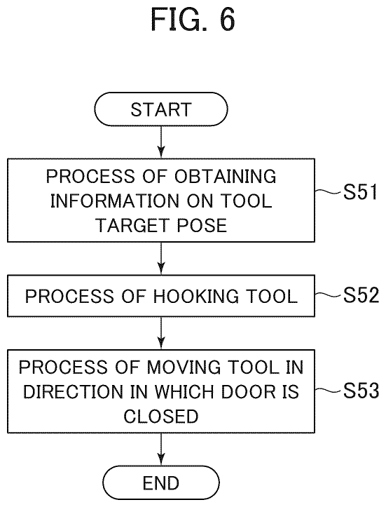

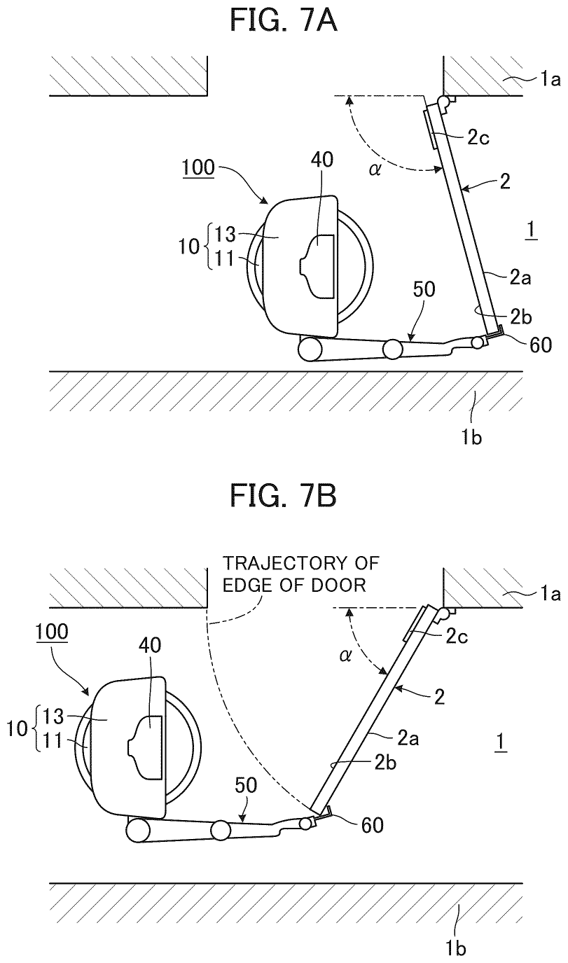

FIG. 6 is a detailed flowchart of the door pulling motion process (S15). FIGS. 7A and 7B are diagrams for describing a door pulling motion of the robot 100, shown correspondingly to FIG. 2. As obvious from FIG. 6, when the door pulling motion process starts, the controller 80 performs a process of obtaining information on a tool target pose to hook the tool 60 on an edge of the door 2 (S51). The information on the tool target pose is expressed by a user beforehand in a coordinate system of the marker 2c, and is stored in a storage unit (not shown). The tool target pose is indicated by a dash-double-dot line in FIGS. 4A and 4B. The motion decision unit 82 obtains the information on the tool target pose expressed in the coordinate system of the marker 2c by reading the information from the storage unit.

The information on the tool target pose is not limited to a form expressed by the user beforehand in the coordinate system of the marker 2c. For example, the information on the tool target pose may be obtained by estimating an orientation of the edge (abutment face) of the door 2, based on the recognized pose of the door 2 and a general door thickness or a door thickness obtained by user input.

After the process of obtaining the information on the tool target pose (S51), the controller 80 performs a process of hooking the tool 60 on the edge of the door 2 by moving the tool 60 (S52). Specifically, the controller 80 drives the mobile wheeled platform 11, the torso part 13, the arm part 50, and the tool 60 in such a manner that the tool 60 moves to the tool target position and the orientation of the tool 60 becomes the tool target orientation. Thus, the tool 60 is hooked on the door 2 as shown in FIG. 7A.

Referring back to FIG. 6, after the process of hooking the tool (S52), the controller 80 performs a process of moving the tool 60 in a direction in which the door 2 is closed (S53). Specifically, the controller 80 drives the mobile wheeled platform 11, the torso part driving means 73, the arm part 50, and the tool 60 in such a manner that the tool 60 moves in the direction in which the door 2 is closed. Thus, the tool 60 moves in the direction in which the door 2 is closed as shown in FIG. 7B. Since the tool 60 is hooked on the door 2, the door 2 follows the tool 60 and turns in the closing direction. Accordingly, the opening angle α of the door 2 can be decreased without making the mobile base 10 move to the front face 2a side of the door 2.

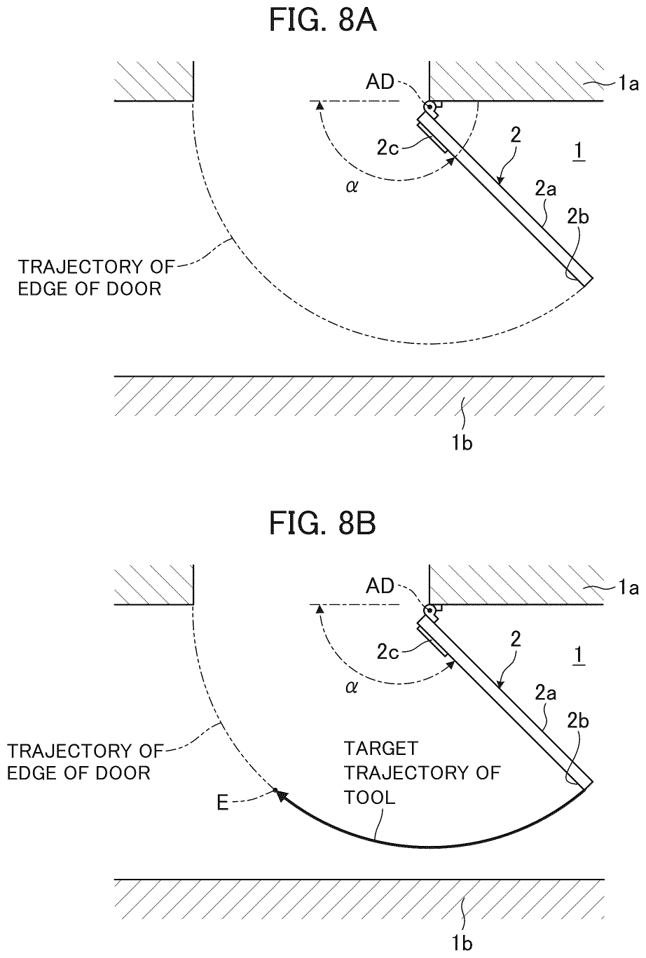

FIG. 8A is a diagram for describing a trajectory of the edge of the door 2, and FIG. 8B is a diagram for describing a trajectory of the tool 60 moving in the direction in which the door 2 is closed. When the door 2 closes, the trajectory of the edge of the door 2 is an arc around the rotation axis AD, as indicated by a dash-double-dot line in FIG. 8A. in order to turn the door 2 in the closing direction by using the tool 60, the tool 60 needs to be moved in such a manner that the trajectory of the tool 60 becomes an arc around the rotation axis AD.

Accordingly, in the present embodiment, the trajectory of the arc is calculated based on the width and the opening angle α of the door 2. The calculated trajectory of the arc is set as a target trajectory of the tool 60, and the tool 60 is moved. The tool 60 therefore moves along the trajectory of the edge of the door 2, as indicated by a thick arrow in FIG. 8B. Accordingly, the tool 60 can be moved with the tool 60 being hooked on the edge of the door 2, and the opening angle α of the door 2 can be decreased.

Information on the width of the door 2 may be obtained by being read from the storage unit (not shown), or may be obtained by recognizing the marker 2c. Information on the opening angle α can be obtained by recognizing the marker 2c.

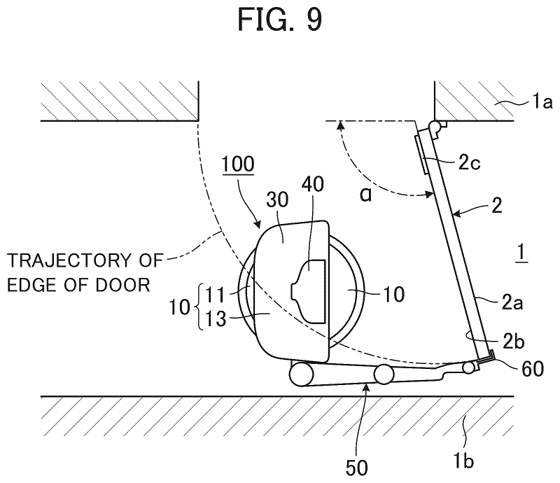

FIG. 9 is a diagram in which the trajectory of the edge of the door 2 is depicted on the plane view shown in FIG. 7A. As obvious from FIG. 9, the mobile base 10 is within an area where the door 2 passes. Accordingly, if the tool 60 is moved by driving only the arm part 50 without moving the mobile base 10, then the mobile base 10 and the door 2 interfere with each other.

For such a reason, in the process of moving the tool 60 in the direction in which the door 2 is closed (S53), it is preferable to cause the mobile wheeled platform 11 to move. In such a case, as shown in FIG. 7B, the mobile base 10 exits from the area where the door 2 passes, with the turn of the door 2. Accordingly, the interference between the mobile base 10 and the door 2 can be prevented, and the opening angle α of the door 2 can be further decreased.

Referring back to FIGS. 8A and B, when the tool 60 is moved according to the set target trajectory up to an end point E of the target trajectory, the process of moving the tool 60 in the direction in which the door 2 is closed (S53) is terminated. Thus, the door pulling motion is completed.

Referring back to FIG. 5, when the door pulling motion process (S15) is completed, a door pushing motion process of pushing the door 2 to close the door 2 is performed (S16).

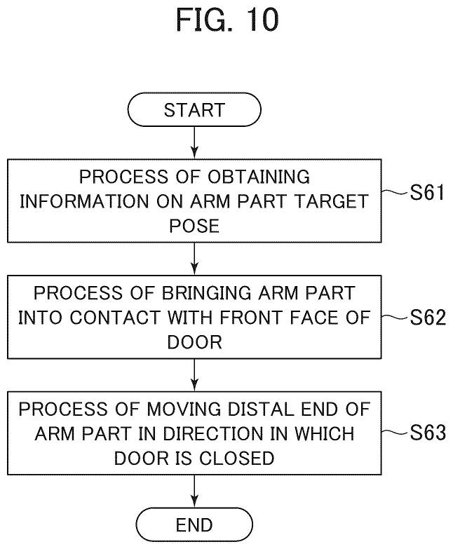

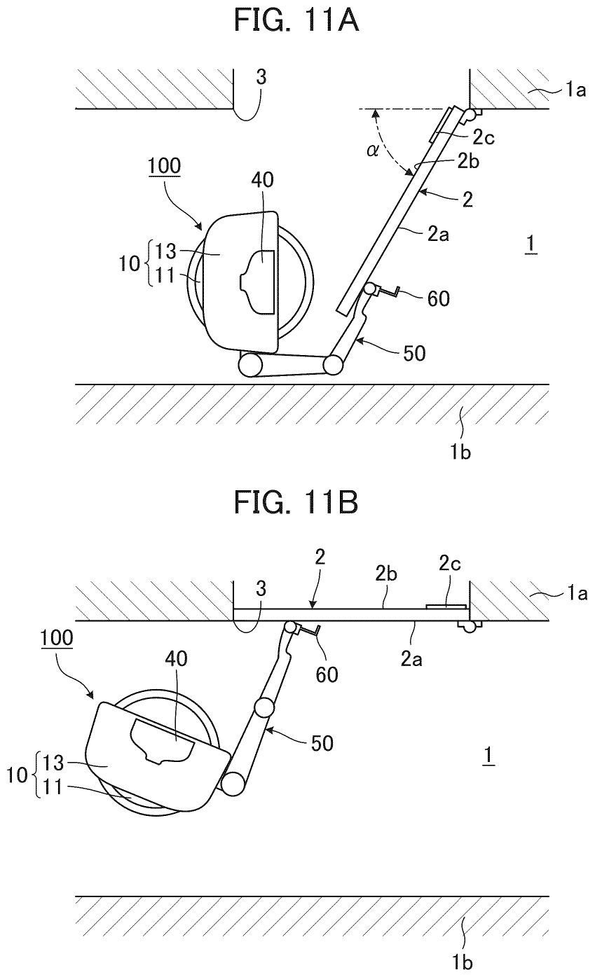

FIG. 10 is a detailed flowchart of the door pushing motion process (S16). FIGS. 11A and 11B are diagrams for describing a door pushing motion of the robot 100, shown correspondingly to FIG. 2. As obvious from FIG. 10, when the door pushing motion process starts, the controller 80 performs a process of obtaining information on an arm part target pose to bring the distal end of the arm part 50 into contact with the front face 2a of the door 2 (S61). The information on the arm part target pose is expressed beforehand in the coordinate system of the marker 2c and is stored in the storage unit (not shown). The controller 80 obtains the information on the arm part target pose expressed in the coordinate system of the marker 2c by reading the information from the storage unit.

After the process of obtaining the information on the arm part target pose (S61), a process of bringing the distal end of the arm part 50 into contact with the front face 2a of the door 2 is performed (S62). Specifically, the controller 80 drives the mobile wheeled platform 11, the torso part 13, the arm part 50, and the tool 60 in such a manner that the arm part 50 moves to the arm part target position and the posture of the arm part 50 becomes the arm part target postureorientation. Thus, as shown in FIG. 11A, the distal end of the arm part 50 comes into contact with the front face 2a of the door 2.

Referring back to FIG. 10, after the process of bringing the distal end of the arm part 50 into contact with the front face 2a of the door 2 (S62), the controller 80 performs a process of moving the distal end of the arm part 50 in the direction in which the door 2 is closed (S63). Specifically, the controller 80 drives the mobile wheeled platform 11, the torso part driving means 73, the arm part 50, and the tool 60 in such a manner that the distal end of the arm part 50 moves in the direction in which the door 2 is closed. Thus, as shown in FIG. 11B, the distal end of the arm part 50 moves in the direction in which the door 2 is closed. Since the distal end of the arm part 50 is in contact with the front face 2a of the door 2, the door 2 is pushed by the distal end of the arm part 50 and turns until reaching a door frame 3. Accordingly, the door 2 can be closed.

Referring back to FIG. 10, when the process of moving the distal end of the arm part 50 in the direction in which the door 2 is closed (S63) is completed, the door pushing motion process (S16) is terminated.

In the example shown in FIGS. 11A and 11B, the door 2 is pushed, without making the mobile base 10 move to the front face 2a side of the door 2. After the door pulling motion process (S15), when it is possible to make the mobile base 10 move to the front face 2a side of the door 2, the mobile base 10 may be moved to the front face 2a side of the door 2, and then the door 2 may be pushed.

In the door pushing motion, the door 2 may be pushed by driving only any one of the mobile wheeled platform 11, the torso part 13, and the arm part 50, or the door 2 may be pushed by driving two or all of the mobile wheeled platform 11, the torso part 13, and the arm part 50. In other words, the door 2 may be pushed by driving at least one of the mobile wheeled platform 11, the torso part 13, and the arm part 50.

Referring back to FIG. 5, when the door pushing motion process (S16) is completed, the process for the motion of closing the door 2 is terminated.

### 2. Second Embodiment

Next, a second embodiment of the present invention is described. Note that in the following, the same components as those in the first embodiment are denoted by the same reference signs.

In the above-described first embodiment, in the process of moving the tool in the direction in which the door is closed (S53 in FIG. 6), the trajectory of the arc is calculated based on the width and the opening angle α of the door 2, and the calculated trajectory of the arc is set as a target trajectory of the tool 60. Accordingly, information on the width and the opening angle α of the door 2 is needed, and a process of setting the target trajectory can be complicated.

Accordingly, in the present embodiment, the controller 80 drives the arm part 50 through impedance control in which the position of the tool 60 and force applied to the door 2 from the tool 60 are controlled by setting a virtual mechanical impedance (inertia, coefficient of attenuation, stiffness, or the like) between the tool 60 and the door 2.

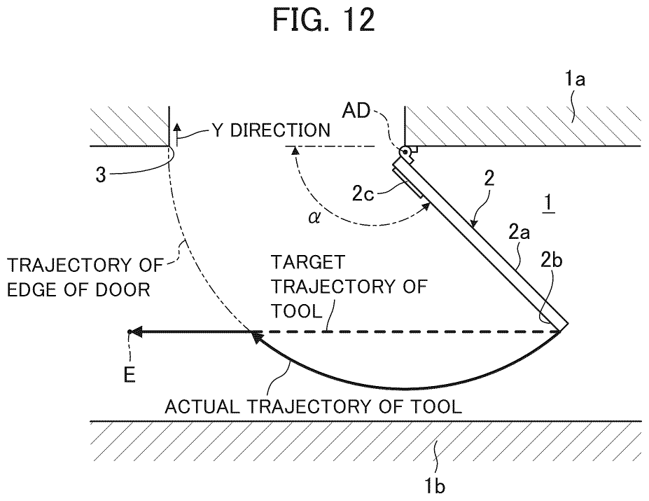

The impedance control is, for example, control of gently moving the arm part 50. Specifically, when no external force is applied to the arm part 50, the arm part 50 is driven in such a manner that the tool 60 moves along a target trajectory. When external force is applied to the arm part 50, the arm part 50 is driven in such a manner that the external force is reduced even if the tool 60 results in deviating from the target trajectory. The trajectory of the arm part 50 driven through the impedance control is described with reference to FIG. 12.

FIG. 12 is a diagram of the trajectory of the arm part 50 driven through the impedance control, shown correspondingly to FIGS. 8A and 8B. FIG. 12 shows an example in which a straight trajectory (see a thick dashed arrow) extending from the edge of the door 2 in the direction in which the door 2 is closed is set as a target trajectory of the tool 60. When the arm part 50 is driven through the impedance control based on such a target trajectory, the tool 60 moves while receiving reaction force from the door 2 up to a point where the target trajectory of the tool 60 and the trajectory of the edge of the door 2 intersect. In other words, the tool 60 moves along the trajectory of the edge of the door 2, as indicated by a thick arrow in FIG. 12.

As described above, in the process of moving the tool in the direction in which the door is closed (S53 in FIG. 6), the tool 60 can be moved along the trajectory of the edge of the door 2 by driving the arm part 50 through the impedance control, without calculating the trajectory of the arc based on the width and the opening angle α of the door 2. Accordingly, the process by the motion decision unit 82 can be simplified, and the opening angle α of the door 2 can be decreased.

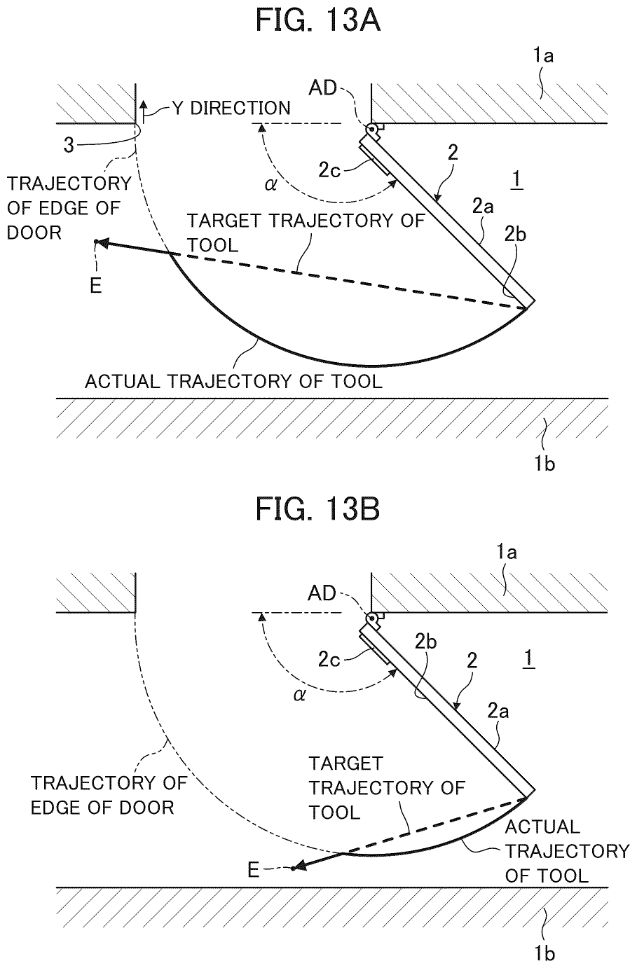

Although the target trajectory of the tool 60 is set to be substantially parallel to the door frame 3 in the example shown in FIG. 12, the target trajectory of the tool 60 may not be parallel to the door frame 3. For example, as shown in FIG. 13A, the target trajectory of the tool 60 may be set at an angle with respect to the door frame 3 in such a manner as to come closer to the door frame 3. As shown in FIG. 13B, the target trajectory of the tool 60 may be set at an angle with respect to the door frame 3 in such a manner as to go farther away from the door frame 3.

### 3. Third Embodiment

Next, a third embodiment of the present invention is described. Note that in the following, the same components as those in the first and second embodiments are denoted by the same reference signs.

In the above-described second embodiment, in the process of moving the tool in the direction in which the door is closed (S53 in FIG. 6), a straight trajectory (see the thick dashed arrow) extending from the edge of the door 2 in the direction in which the door 2 is closed is set as a target trajectory of the tool 60 (see FIGS. 12 and 13). When the target trajectory of the tool 60 is set at an angle with respect to the door frame 3 in such a manner as to go farther away from the door frame 3 as shown in FIG. 13B, the distance over which the tool 60 moves along the trajectory of the edge of the door 2 is shorter. Accordingly, there is a possibility that the opening angle α of the door 2 cannot be made sufficiently small in one door pulling motion. In order to make the opening angle α of the door 2 sufficiently small in one door pulling motion, it is necessary to set a target trajectory of the tool 60 with accuracy and move the tool 60 longer along the trajectory of the edge of the door 2, and an advanced technique is aimed.

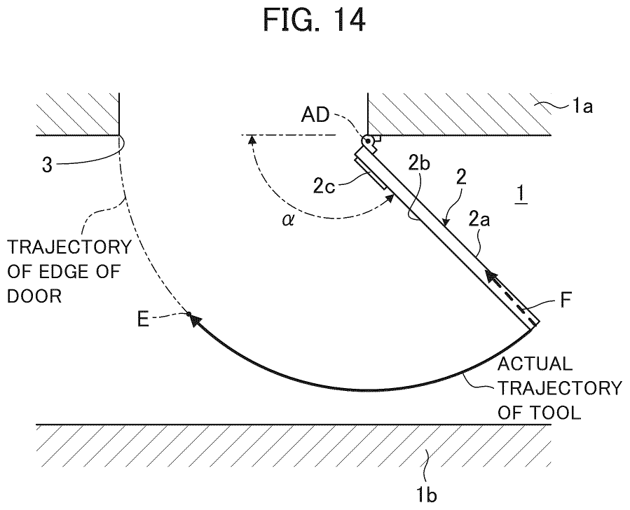

Accordingly, in the present embodiment, the arm part 50 is driven through impedance control in such a manner that force F acts on the door 2 from the tool 60 toward the rotation axis AD of the door 2, as indicated by a thick dashed line in FIG. 14. Accordingly, the tool 60 is pressed against the door 2 toward the rotation axis AD of the door 2 even if the door 2 turns. Accordingly, the tool 60 can be moved longer along the trajectory of the edge of the door 2, without setting a target trajectory of the tool 60 with accuracy, and the opening angle α of the door 2 can be easily decreased.

### 4. Fourth Embodiment

Next, a fourth embodiment of the present invention is described. Note that in the following, the same components as those in the first and second embodiments are denoted by the same reference signs.

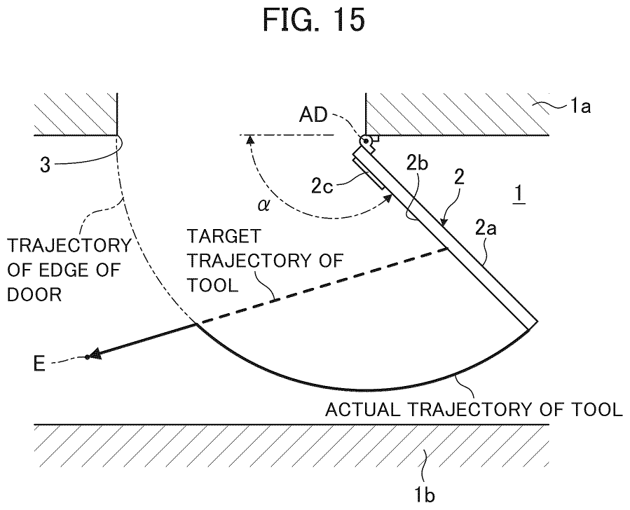

FIG. 15 is a diagram for describing a target trajectory of the tool 60 in the present embodiment. As shown in FIG. 15, the controller 80 in the present embodiment, as in the second embodiment, sets a straight trajectory extending from the door 2 in the direction in which the door 2 is closed as a target trajectory of the tool 60, and drives the arm part 50 through impedance control. However, in contrast to the second embodiment (see FIGS. 12, 13 (a) and 13 (b)) in which the target trajectory extends in such a manner as to pass the edge of the door 2, that is, the tool 60, the target trajectory in the present embodiment, as shown in FIG. 15, extends in such a manner as to pass a nearer side to the rotation axis AD of the door 2 than the edge of the door 2, that is, the tool 60. Accordingly, the distance over which the tool 60 moves along the trajectory of the edge of the door 2 becomes long, compared to the case where the target trajectory passes the edge of the door 2, that is, the tool 60. Accordingly, the tool 60 can be moved longer along the trajectory of the edge of the door 2, without setting a target trajectory of the tool 60 with accuracy, and the opening angle α of the door 2 can be easily decreased.

### 5. Fifth Embodiment

Next, a fifth embodiment of the present invention is described. Note that in the following, the same components as those in the first embodiment are denoted by the same reference signs.

In the door pulling motion process (S15 in FIG. 5 and the flowchart shown in FIG. 6) in the above-described first embodiment, the information on the tool target pose is obtained, and the tool 60 is moved to the tool target position and the orientation of the tool 60 is made to become the tool target orientation, whereby the tool 60 is hooked on the edge of the door 2. In the present embodiment, impedance control is used to hook the tool 60 on the edge of the door 2.

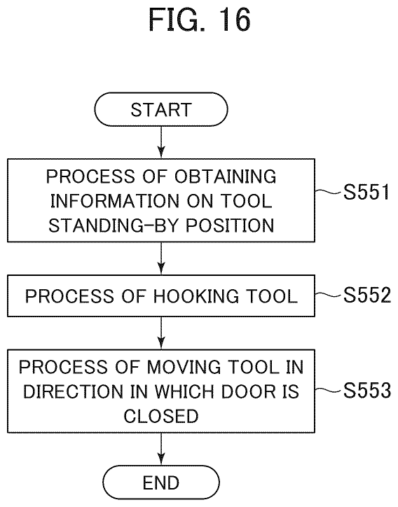

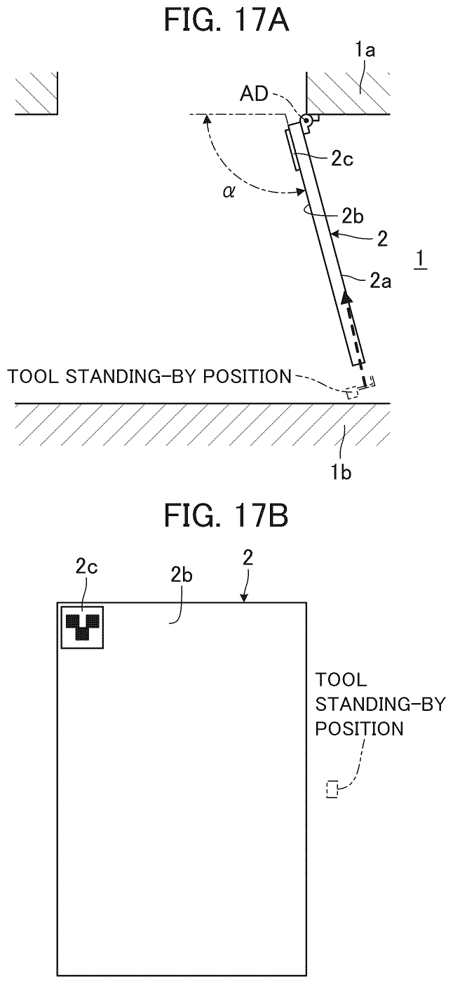

FIG. 16 is a detailed flowchart of a door pulling motion process (S15 in FIG. 5) in the present embodiment. FIGS. 17A and 17B are diagrams for describing a process for a motion of hooking the tool 60 on the edge of the door 2, shown correspondingly to FIGS. 4A and 4B. As obvious from FIG. 16, when the door pulling motion process starts, the motion decision unit 82 performs a process of obtaining information on a tool standing-by position to hook the tool 60 on the edge of the door 2 (S551).

As shown in FIGS. 17A and 17B, the tool standing-by position is, when viewed in the vertical direction, a position away from the edge of the door 2 in a radial direction around the rotation axis AD of the door 2. The information on the tool standing-by position is expressed by a user beforehand in the coordinate system of the marker 2c and is stored in the storage unit (not shown). The controller 80 obtains the information on the tool standing-by position expressed in the coordinate system of the marker 2c by reading the information from the storage unit.

Referring back to FIG. 16, after the process of obtaining the information on the tool standing-by position (S551), a process of moving the tool 60 and hooking the tool 60 on the edge of the door 2 is performed (S552). Specifically, the controller 80 moves the tool 60 to the tool standing-by position. Thereafter, the arm part 50 is driven through impedance control, based on a trajectory passing the tool 60 and going toward the rotation axis AD of the door 2, as a target trajectory of the tool 60. Thus, the tool 60 moves toward the edge of the door 2 and comes into contact with the edge of the door 2. Thereafter, the tool 60 stops moving, and the process of hooking the tool 60 on the edge of the door 2 (S552) is completed.

Determination of whether the tool 60 comes into contact with the edge of the door 2 is performed based on external force applied to the tool 60. Specifically, it is determined that the tool 60 is not in contact with the edge of the door 2 when the external force applied to the tool 60 is less than a threshold value, and it is determined that the tool 60 comes into contact with the edge of the door 2 when the external force applied to the tool 60 reaches the threshold value. For detection of the external force, for example, a force sensor, a torque sensor, or the like can be used.

After the process of hooking the tool 60 on the door 2 (S552), a process of moving the tool 60 in the direction in which the door 2 is closed is performed (S553). Since the process of moving the tool 60 in the direction in which the door 2 is closed (S553) is almost similar to the processes in the first to fourth embodiment, details thereof are omitted.

### 6. Sixth Embodiment

Next, a sixth embodiment of the present invention is described. Note that in the following, the same components as those in the first embodiment are denoted by the same reference signs.

In the door pulling motion process (S15 in FIG. 5 and the flowchart shown in FIG. 6) in the first embodiment described above, the information on the tool target pose expressed in the coordinate system of the marker 2c is obtained, and the tool 60 is hooked on the edge of the door 2.

In the present embodiment, a vicinity of the edge of the door 2 is recognized as a representative point 2d in a coordinate system of the door frame 3, and a tool target position is calculated based on the representative point 2d. For the representative point 2d, for example, a sticker provided in the vicinity of the edge of the door 2 can be used.

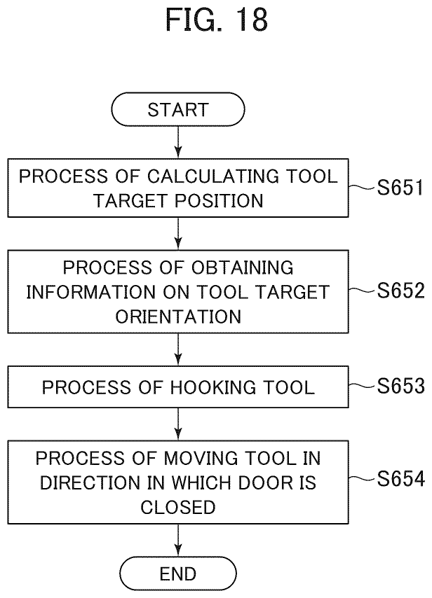

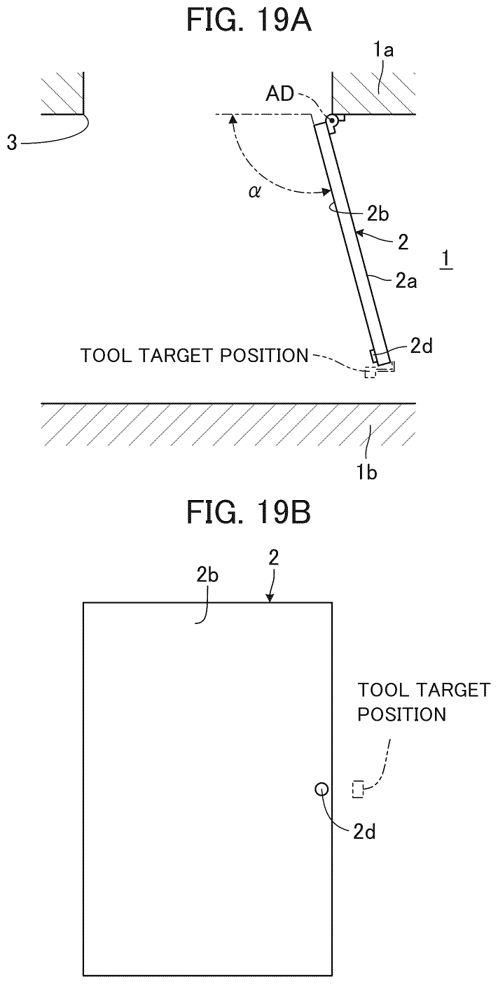

FIG. 18 is a detailed flowchart of a door pulling motion process (S15 in FIG. 5) in the present embodiment. FIGS. 19A and 19b are diagrams for describing a process for a motion of hooking the tool 60 on the edge of the door 2, shown correspondingly to FIGS. 4A and 4B. As obvious from FIG. 18, when the door pulling motion process starts, the controller 80 performs a process of calculating a tool target position to hook the tool 60 on the edge of the door 2 (S651).

As shown in FIGS. 19A and 19B, the tool target position is, when viewed in the vertical direction, a position away from the representative point 2d in a direction going away from the edge of the door 2. Information on the tool target position with respect to the representative point 2d is expressed by a user beforehand in the coordinate system of the door frame 3 and is stored in the storage unit (not shown). The controller 80 obtains the information on the tool target position with respect to the representative point 2d by reading the information from the storage unit, and calculates a tool target position with respect to the mobile base 10, based on the obtained information on the tool target position and information on the position of the recognized representative point 2d.

After the process of calculating the tool target position (S651), the controller 80 performs a process of obtaining information on a tool target orientation to hook the tool 60 on the edge of the door 2 (S652). The information on the target orientation of the tool 60 is expressed by a user beforehand in the coordinate system of the door frame 3 and is stored in the storage unit (not shown). The controller 80 obtains the information on the tool target orientation expressed in the coordinate system of the door frame 3 by reading the information from the storage unit.

After the process of obtaining the information on the tool target orientation (S652), a process of moving the tool 60 and hooking the tool 60 on the edge of the door 2 is performed (S653), and then a process of moving the tool 60 in the direction in which the door 2 is closed is performed (S654). Since the process of hooking the tool (S653) and the process of moving the tool in the direction in which the door is closed (S654) are almost similar to the processes in the first to fourth embodiments, details thereof are omitted.

Note that in the present embodiment, impedance control may be used to hook the tool 60 on the edge of the door 2 as in the fifth embodiment. In other words, in place of the calculation of the tool target position, a tool standing-by position to hook the tool 60 on the edge of the door 2 may be calculated, the tool 60 may be moved to the calculated tool standing-by position, and then the tool 60 may be hooked on the edge of the door 2 by driving the arm part 50 through impedance control.

### 7. Seventh Embodiment

Next, a seventh embodiment of the present invention is described. Note that in the following, the same components as those in the first embodiment are denoted by the same reference signs.

In the first embodiment, as shown in FIG. 5, after the door pulling motion process (S15), the door pushing motion process (S16) is performed. The door pulling motion process is terminated when the tool 60 is moved according to the set target trajectory up to the end point E of the target trajectory, as shown in FIG. 12.

However, the tool 60 may come off the edge of the door 2 in a door pulling motion. If the tool 60 comes off the edge of the door 2, then the door 2 does not turn even if the tool 60 moves according to the target trajectory. In other words, the movement of the tool 60 after the tool 60 comes off the edge of the door 2 does not contribute to the turn of the door 2. Accordingly, this results in inefficiency.

Accordingly, in the present embodiment, the controller 80 terminates the door pulling motion process (S15 in FIG. 5) when the tool 60 comes off the edge of the door 2, and starts the door pushing motion process (S16 in FIG. 5). Accordingly, a time period of transition to a door pushing motion after the tool 60 comes off the edge of the door 2 in a door pulling motion is shortened. Accordingly, the door 2 can be closed efficiently.

Determination of whether the tool 60 comes off the edge of the door 2 can be performed based on external force applied to the tool 60. Specifically, the controller 80 determines that the tool 60 does not come off the edge of the door 2 when the external force applied to the tool 60 is a threshold value or more, and determines that the tool 60 is away from the edge of the door 2 when the external force is less than the threshold value. For detection of the external force, for example, a force sensor or a torque sensor can be used.

The present embodiment is more preferable when the door 2 is turned in the closing direction by driving the arm part 50 through impedance control, as in the second to fourth embodiments.

### 8. Eighth Embodiment

Next, an eighth embodiment of the present invention is described. Note that in the following, the same components as those in the first embodiment are denoted by the same reference signs.

In the door pushing motion in the first embodiment, as shown in FIGS. 11A and 11B, the distal end of the arm part 50 is brought into contact with the front face 2a of the door 2 after the door pulling motion, and the door 2 is pushed in the direction in which the door 2 is closed, whereby the door 2 is closed. However, there are some cases where it is difficult to bring the distal end of the arm part 50 into contact with the front face 2a of the door 2, depending on the size of the opening angle α of the door 2 after the door pulling motion.

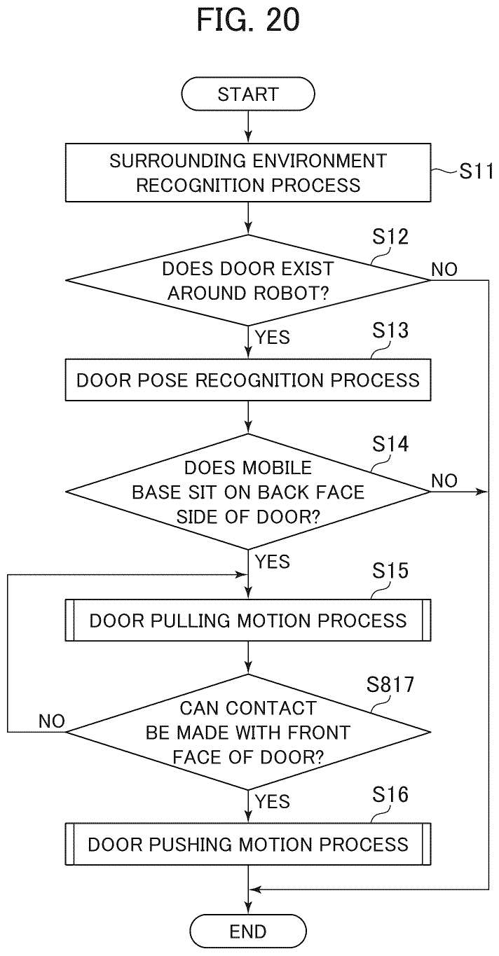

Accordingly, in the present embodiment, the controller 80 determines whether the distal end of the arm part 50 can be brought into contact with the front face 2a of the door 2 after the door pulling motion, and starts the door pushing motion process when it is determined that the distal end of the arm part 50 can be brought into contact. Hereinafter, a flow of motions according to the present embodiment is described in detail with reference to FIG. 20.

FIG. 20 is a flowchart of motions according to the present embodiment. As obvious from FIG. 20, after the door pulling motion process (S15), the controller 80 performs a process of determining whether the distal end of the arm part 50 can be brought into contact with the front face 2a of the door 2 (S817). When the distal end of the arm part 50 can be brought into contact with the front face 2a of the door 2 (YES at S817), the door pushing motion process (S16) is performed. When the distal end of the arm part 50 cannot be brought into contact with the front face 2a of the door 2 (NO at S817), the door pulling motion process (S15) is performed again.

Determination of whether the distal end of the arm part 50 can be brought into contact with the front face 2a of the door 2 is performed based on a result of planning a trajectory of the arm part 50. Specifically, the controller 80 first sets a target position for the distal end of the arm part 50 to push the front face 2a of the door 2. Next, an attempt is made to see whether a trajectory of the arm part 50 along which the distal end of the arm part 50 is moved to the target position can be planned. When the trajectory can be planned, it is determined that the distal end of the arm part 50 can be brought into contact with the front face 2a of the door 2, and when the trajectory cannot be planned, it is determined that the distal end of the arm part 50 cannot be brought into contact with the front face 2a of the door 2. For planning of the trajectory of the arm part 50, a rapidly exploring random tree (RRT) or the like can be used.

As described above, in the present embodiment, when the distal end of the arm part 50 cannot be brought into contact with the front face 2a of the door 2, the door pulling motion process is performed again. Accordingly, the opening angle α of the door 2 is decreased to such an extent that the distal end of the arm part 50 can be brought into contact with the front face 2a of the door 2. Accordingly, the door 2 can be more reliably closed.

### 9. Ninth Embodiment

Next, a ninth embodiment of the present invention is described. Note that in the following, the same components as those in the eighth embodiment are denoted by the same reference signs.

In the eighth embodiment, it is determined whether the distal end of the arm part 50 can be brought into contact with the front face 2a of the door 2, based on planning of a trajectory of arm part 50. In the present embodiment, it is determined whether the distal end of the arm part 50 can be brought into contact with the front face 2a of the door 2, based on planning of a path of the mobile base 10.

Specifically, the controller 80 first sets a target position for the distal end of the arm part 50 to push the front face 2a of the door 2. Next, based on the set target position, a position at a predetermined distance from the door 2 is set as a target position of the mobile base 10. Next, an attempt is made to plan a path along which the mobile base 10 is moved to the target position of the mobile base 10. When the path can be planned, it is determined that the distal end of the arm part 50 can be brought into contact with the front face 2a of the door 2 by making the mobile base 10 move, and when the path cannot be planned, it is determined that the distal end of the arm part 50 cannot be brought into contact with the front face 2a of the door 2. For planning of the path of the mobile base 10, Dijkstra's algorithm or the like can be used, based on an environment map and information on the own position on the map.

In the present embodiment, as in the eighth embodiment, the door pulling motion process is also performed again when the distal end of the arm part 50 cannot be brought into contact with the front face 2a of the door 2. Accordingly, the opening angle α of the door 2 is decreased to such an extent that the distal end of the arm part 50 can be brought into contact with the front face 2a of the door 2. Accordingly, the door 2 can be more reliably closed.

### 10. Modifications

The present invention can be implemented with various changes.

(10.1 Modification of Location where Tool is Hooked)

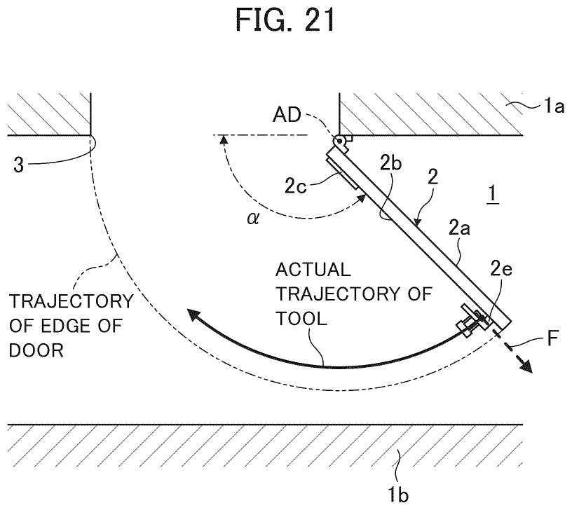

Although the tool 60 is hooked on the edge of the door 2 in the above-described embodiments, a location where the tool 60 is hooked is not limited to the edge of the door 2. For example, as shown in FIG. 21, when the door 2 has a doorknob 2e, the tool 60 may be hooked on the doorknob 2e.

FIG. 21 is a diagram showing a state in which the tool 60 is hooked on the doorknob 2e of the door 2, shown correspondingly to FIGS. 4A to 4B. As shown in FIG. 21, the tool 60 is hooked on the doorknob 2e from a rotation axis AD side. Also in such a case, a door pulling motion can be performed, and the opening angle α of the door 2 can be decreased.

When the tool 60 is hooked on the doorknob 2e of the door 2, and when the arm part 50 is driven through impedance control as in the third embodiment, the tool 60 is pressed against the doorknob 2e of the door 2 even if the door 2 turns, by causing force F to act on the door 2 from the tool 60 in a direction going away from the rotation axis AD of the door 2. Accordingly, the tool 60 can be moved longer along the trajectory of the edge of the door 2, without setting a target trajectory of the tool 60 with accuracy, and the opening angle α of the door 2 can be easily decreased.

A place where the tool 60 is hooked is not limited to the edge and the doorknob 2e of the door 2, and the tool 60 may be hooked around a center of the front face 2a of the door 2, on a protrusion on the door 2, or the like. In other words, it suffices that the tool 60 can be hooked on the door 2.

### (10.2 Modification of Tool)

The tool 60 is not limited to a form that can be hooked on the door 2. The door 2 may be held by gripping the edge or the doorknob 2e of the door 2 with a gripper or a hand as the tool 60. Moreover, the door 2 may be held by magnetic force between magnets or an electromagnets as the tool 60. The door 2 may be held by vacuum suction with a nozzle connected to a vacuum generator as the tool 60.

Although some embodiments of the present invention have been described hereinabove, the above-described embodiments only illustrate some examples of application of the present invention and are not intended to limit the technical scope of the present invention to the specific configurations of the above-described embodiments. Any of the above-described embodiments can be combined as appropriate to such an extent that no inconsistency occurs.

### INDUSTRIAL APPLICABILITY

The present invention is available at least in industries where robots and the like are manufactured.

### REFERENCE SIGNS LIST

100 Robot
2 Door
2a Front face
2b Back face
10 Mobile base
11 Mobile wheeled platform
12 Leg part
13 Torso part
40 Head part
41 Image generation means
50 Arm part
51 First joint part
52 First link part
53 Second joint part
54 Second link part
55 Third joint part
60 Tool
61 Corner portion
71 Wheeled platform driving means
73 Torso part driving means
74 Head part driving means
75 Arm part driving means
76 Tool driving means
80 Controller
81 Surrounding environment recognition unit
82 Motion decision unit
83 Signal output unit
AD Rotation axis of door
F Force
α Opening angle

1. A robot comprising:
a mobile base;
an arm part that extends from the mobile base and is driven in such a manner as to be able to change its posture;
a tool that is provided at a distal end of the arm part and is configured to be hooked on or to hold a door; and
a controller that controls driving of the mobile base and of the arm part, and
wherein the door has a front face that is a face facing the mobile base in a closed state, and a back face that is a rear face opposite to the front face, and
wherein the controller
drives the mobile base and/or the arm part in a situation where the mobile base is on a back face side of the opened door, to hook the tool on the door or to make the tool hold the door,
drives the mobile base and/or the arm part to move the tool hooked on or holding the door in a direction in which the door is closed and thus to decrease an opening angle of the door, and
drives the mobile base and/or the arm part to push the front face of the door with the decreased opening angle.

2. The robot according to claim 1, wherein when the tool hooked on or holding the door comes off the door, the controller stops moving the tool in the direction in which the door is closed, and initiates a motion of pushing the front face of the door.

3. The robot according to claim 1, wherein after moving the tool hooked on or holding the door in the direction in which the door is closed, the controller sets a target position of the arm part to push the front face of the door, makes an attempt to see whether it is possible to plan a trajectory of the arm part along which the arm part is moved to the target position, and when the trajectory is successfully planned, initiates a motion of pushing the front face of the door.

4. The robot according to claim 1, wherein after moving the tool hooked on or holding the door in the direction in which the door is closed, the controller sets a target position of the arm part to push the front face of the door, sets a target position of the mobile base based on the target position of the arm part, attempts to plan a path along which the mobile base is moved to the target position of the mobile base, and when the path is successfully planned, initiates a motion of pushing the front face of the door.

5. A method of controlling a robot, the robot comprising a mobile base, an arm part that extends from the mobile base and is driven in such a manner as to be able to change its posture, and a tool that is provided at a distal end of the arm part and is configured to be hooked on or to hold a door, the door having a front face that is a face facing the mobile base in a closed state, and a back face that is a rear face opposite to the front face, the control method comprising the steps of:
driving the mobile base and/or the arm part in a situation where the mobile base is on a back face side of the opened door, to hook the tool on the door or to make the tool hold the door;
driving the mobile base and/or the arm part to move the tool hooked on or holding the door in a direction in which the door is closed and thus to decrease an opening angle of the door; and
driving the mobile base and/or the arm part to push the front face of the door with the decreased opening angle.

6. A program of controlling a robot, the robot comprising a mobile base, an arm part that extends from the mobile base and is driven in such a manner as to be able to change its posture, and a tool that is provided at a distal end of the arm part and is configured to be hooked on or to hold a door, the door having a front face that is a face facing the mobile base in a closed state, and a back face that is a rear face opposite to the front face, the control program comprising the steps of:
driving the mobile base and/or the arm part in a situation where the mobile base is on a back face side of the opened door, to hook the tool on the door or to make the tool hold the door;
driving the mobile base and/or the arm part to move the tool hooked on or holding the door in a direction in which the door is closed and thus to decrease an opening angle of the door; and
driving the mobile base and/or the arm part to push the front face of the door with the decreased opening angle.
